(19) United States
(12) Patent Application Publication
(10) Pub. No.: US 2007/0083637 A1
(43) Pub. Date: Apr. 12, 2007

(54) Protection from undesirable messages

(75) Inventor: Michael Greve, Karlsruhe (DE)

Correspondence Address: DAVIDSON, DAVIDSON & KAPPEL, LLC, 485 SEVENTH AVENUE, 14TH FLOOR, NEW YORK, NY, 10018, US

(73) Assignee: 1& 1 Internet AG, Montabaur (DE)

(21) Appl. No.: 10/576,860

(22) PCT Filed: Oct. 21, 2004
(86) PCT No.: PCT/EP04/11934

§ 371 Date: Apr. 21, 2006

Related U.S. Application Data
(60) Provisional application No. 60/574,495, filed on May 26, 2004.

(30) Foreign Application Priority Data
Oct. 24, 2003 (DE) 10349627.0

(51) Int. Cl. G06F 15/173

(52) U.S. Cl. 709/224

(57) ABSTRACT

A method and system for monitoring messages addressed to a first receiver (E1), comprising a first receiver (E1) which contains a first undesirable receiver device (UNE) and which prevents a user of the first receiver (E1) from accessing the undesirable receiver (UNE), wherein a message category is defined as undesirable, and messages which are to be prevented from being made available to a user of the first receiver (E1) a re indicated. Verification occurs as to whether a message (M) addressed to the first receiver (E1) falls into the undesirable category. If the message (M) falls into the undesirable category, it is assigned to the undesirable receiver device (UNE). The first receiver (E1) is configured in such a way that the undesirable receiver (UNE) can only be accessed by a second receiver (E2). The first receiver (E1) is, f or example, an e-mail account of a child and the second receiver E2) is the e-mail account of an adult who can prevent the child from accessing undesirable messages, particularly Spam.

### FIELD OF THE INVENTION

The present invention relates in general to the field of communication technology and in particular to a monitoring of messages, especially in connection with undesirable e-mails sent to children.

### BACKGROUND OF THE INVENTION

In modern communication environments messages can be delivered to a receiver who is not supposed to receive them. It is known in particular in computer-based communication environments, such as for example the Internet, that messages in the form of e-mails are delivered to receivers who are not supposed to receive them.

There thus exists a problem for example in that, when using an e-mail account on the Internet, children receive undesirable and unknown e-mails. However, these e-mails are seldom suitable for this young target group and may contain e.g. pornographic content, untrustworthy offers such as e.g. financial services, gambling offers, undesirable product offers, offers of prescription-only drugs, etc.

A further problem is that parents have no control over the communication behaviour of their children and thus also cannot protect their children from undesirable and unknown e-mails. Furthermore it is undesirable that the user of a business e-mail account for example receives private e-mails which do not fall into the framework of the business

In the field of computer-based network environments and in particular in e-mails transmitted via the Internet the use of so-called filters (e.g. spam filters) to prevent the receipt of undesirable messages, is known. Here we can differentiate between two approaches.

In one approach it is possible to check messages in the form of e-mails for their contents and sender before their transmission to an intended receiver and optionally not to deliver e-mails recognized as undesirable to the receiver. In this case the receiver receives no e-mails recognized as undesirable according to the filtering used. This has the disadvantage that the receiver receives no knowledge of which e-mails have been recognized as undesirable and correspondingly not transmitted. Therefore it is possible that the receiver does not receive e-mails wrongly classified as undesirable, i.e. desirable e-mails are not delivered. In order to prevent this, filters used in this approach are customarily configured such that e-mails are only filtered out and not delivered if it can be established unequivocally that they are undesirable. But this in turn means that the number of e-mails wrongly not recognized as undesirable and transmitted to the receiver may be high.

A method and e-mail system for monitoring messages addressed to a receiver are known from WO 99/37066 A1 in which the receiver is set up in such a way that it has a receiving device which intercepts the undesirable messages (so-called “JUNK”) so that these do not reach the receiver, i.e. that an “undesirable”-type receiving device is already described there. In detail a receiving filter is used there which checks all incoming messages by means of a heuristic investigation in order to establish whether the message could be undesirable or not. Those messages which are allocated to the “undesirable” category receive the so-called “JUNK” status and are not displayed to the user, instead they are automatically deleted from the system. Thus the receiver described here is set up such that access by a user to the “undesirable” receiving device is prevented by not displaying them. An “undesirable” message category is already defined there which indicates those messages which must be prevented from being delivered to the user, wherein a check is implemented to determine whether a message falls into this category and is optionally allocated to the “undesirable” receiving device. As the user has no knowledge about which messages are categorized by the system as “undesirable” and are earmarked for automatic deletion there is also no possibility for a potential manual intervention for correction. Instead the user must accept that the messages automatically deleted by the system are irretrievably lost.

It is known from US 2002/0199095 A1 to provide an “e-mail relay” as a second receiver which pre-filters incoming messages, wherein three different message categories are defined, that is to say “clean”, “spam” and “borderline” (see FIG. 2 of that document) and the e-mails are treated differently accordingly. The e-mails categorized as “clean” correspond to desirable messages which are forwarded directly to the receiver for access by the user. The e-mails recognized as “spam” are undesirable messages which are not forwarded so that the user has no access to these. Finally the e-mails called “borderline” are “borderline cases”, i.e. messages which are not immediately recognized as “clean” or “spam” and therefore have unknown status. These unknown messages are earmarked for further checking (“further review”). In addition these messages are isolated from the others (“quarantined”) and stored in a database memory in order to be able to be investigated in more detail later by a system administrator (“administrator”). This means that the second receiver (“e-mail relay”) is set up such that it has an “unknown” receiving device and at least the user (“administrator”) has access to it. The access possibilities or restrictions which exist for the first receiver and its user are not described in more detail. Thus only an insufficient solution is proposed here for the problem named at the outset.

Moreover a further approach can be used which is also used independently of the previously mentioned approach. Here the e-mails are filtered such that all e-mails addressed to a receiver are transmitted and classified there into desirable and undesirable e-mails. E-mails recognized as undesirable are not rejected, instead they are delivered as e-mails identified as undesirable. This can for example take place by desirable e-mails being allocated to a first folder and undesirable e-mails to a second folder. This has the advantage that the receiver can deliberately access desirable e-mails and disregard undesirable e-mails allocated to the second folder. In contrast to the first approach the receiver has the possibility here, by accessing the second folder, of checking whether these have been wrongly allocated as e-mails recognized as undesirable. However, this also has a disadvantage as e-mails allocated to the second folder can be accessed. Therefore it is possible that for example a minor obtains access to e-mails which e.g. have pornographic contents or glamorize war.

Comparable problems occur in e-mail accounts used for business. Here also it is only possible not to transmit undesirable e-mails, for example e-mails not of a business nature, to the intended receiver assuming correct filtering has taken place, or to deliver e-mails classified into business and non-business e-mails.

### OBJECT OF THE INVENTION

The object of the present invention is to supply solutions which reliably prevent messages aimed at a receiver from being delivered to same if these are undesirable messages, wherein in particular the above-mentioned disadvantages of the state of the art are to be avoided.

### BRIEF DESCRIPTION OF THE INVENTION

Below, terms which are used to define and describe the present invention are used and explained as examples and illustrations:

The first receiver is a first set-up user account in a communications service, such as e.g. e-mail or mobile telephone, SMS (Short Message Service) or MMS (Multimedia Message Service), to which such messages can also be aimed, whose sender and/or content is not known and against which the user of the first receiver is to be protected. In the preferred example the first receiver is the e-mail account of a child who is to be protected against “undesirable” and/or “unknown” messages.

The second receiver is a second set-up user account from which the access to “undesirable” and/or “unknown” messages is prevented by the first receiver. In the preferred example the second receiver is the e-mail account of a legal guardian of the child (parent, teacher etc.), who can monitor “undesirable” and/or “unknown” messages which are aimed at the e-mail mailbox of the child and block them before they are accessed by the child. The child preferably receives only “desirable” messages.

The “undesirable”, “desirable” and “unknown” messages are each received by a correspondingly set-up first, second or third receiving device which, in the case of e-mails, are correspondingly set-up mailbox files. The incoming messages are thus categorized and allocated according to category to a first “undesirable” folder or to a second “desirable” folder or in case of doubt to a third “unknown” folder.

Reference is made to message categories called “undesirable”, desirable” and “unknown”. The “undesirable” message category indicates messages which are to be prevented from being delivered to a user of a receiver which is intended as receiver of a message from a sender. The “desirable” message category indicates messages which are permitted to be delivered to a receiver which is earmarked as receiver by a sender of a message. The “unknown” message category indicates messages which do not fall into either the “undesirable” message category or into the “desirable” message category. Messages from the “unknown” message category are characterized as such and are preferably treated as messages of the “undesirable” message category.

Filtering processes and/or devices are provided to classify messages as “undesirable”, “desirable” and “unknown” messages. Preferred examples of these are given further below.

With regard to the terms “undesirable”, “desirable” and “unknown” it is preferred that these terms are not understood from the point of view of the user to whom messages are addressed, instead (also) from the point of view of an entity for checking messages aimed at the user of the first receiver. Staying with the example of messages sent to a minor the “undesirable” message category can be defined such that it does not take place from the point of view of the minor. Rather it is possible to specify the definition of the “undesirable” message category from the point of view of the parents, supervisors etc. in order to prevent minors from receiving messages that are undesirable from the point of view of such people. The same applies to the message categories “desirable” and “unknown”.

Reference is also made to the delivery of a message. Here it is particularly to be understood that a message is delivered to a user of a receiver such that the message can be used by the user in the manner intended by the sender and/or for the message itself. For example an e-mail is delivered if the user named as addressee can access the e-mail or read, store etc. the e-mail.

Examples of the receiver provided in the present invention include computer systems (e.g. personal computers) designed for communication via a network, in particular the Internet, e-mail accounts etc. As can be seen in the following the term “receiver” can include devices or apparatuses which can receive and send messages (in such cases the term “receiver” can be understood as chosen in differentiation to a sender of a message).

The receivers provided in the present invention for which a checking of messages is to be carried out include at least one receiving device. Examples of devices for receiving provided in the present invention include memory areas allocated to a receiver to store messages, so-called folders of e-mail accounts and the like.

To achieve this object the present invention proposes a method and a system of monitoring messages.

In the method according to the invention messages addressed to a first receiver are monitored, the first receiver being set up such that it has an “undesirable” receiving device and that access to the “undesirable” receiving device by a user of the first receiver is prevented. An “undesirable” message category is defined which indicates messages which are to be prevented from being delivered to a user of the first receiver. A message addressed to the first receiver is tested as to whether it falls into the “undesirable” message category. The message is then allocated to the “undesirable” receiving device if the message falls into the “undesirable” message category, wherein the first receiver is set up such that the “undesirable” receiving device can only be accessed by a second receiver.

This makes possible the use and definition of a monitoring entity which checks the messages of the “undesirable” message category. The second receiver can for example be a receiver (e.g. an e-mail account) used by parents, by means of which the parents monitor messages undesirable for their child.

Several problems of the state of the art are solved in this way.

In the state of the art it is possible that a receiver and thus its user does not receive messages aimed at it at all, i.e. messages are lost if messages are (wrongly) classified as undesirable messages and are not delivered at all. This is prevented by the present invention because messages which are not to be delivered to the user of the first receiver are received by the “undesirable” receiving device, i.e. are not lost.

It is also possible in the state of the art that messages which a user of a receiver is not actually supposed to receive, and which are indeed called messages of this kind (e.g. messages indicated as undesirable or allocated to a special folder), can nevertheless be accessed by the user. This is prevented according to the present invention by messages which fall into the “undesirable” message category being delivered to the “undesirable” receiving device which the user of the first receiver cannot access.

It is for example possible in this way to check whether e-mails addressed to a minor have undesirable contents (e.g. pornographic content) or come from undesirable senders (e.g. political groups, specific relatives), i.e. fall into a correspondingly defined “undesirable” message category. In such cases e-mails aimed at the minor are stored not for use by same (e.g. reading, storing and/or forwarding), but rather are stored in secure access by the “undesirable” receiving device and made available for example to parents.

A further example is a first receiver used for business, the user of which is not supposed to receive any private messages or messages from other companies; for this an “undesirable” message category is defined indicating such messages. Messages aimed at the first receiver used for business are checked against the “undesirable” message category (e.g. does the message come from a private sender) and optionally delivered to a corresponding “undesirable” receiving device.

In a preferred embodiment the first receiver is set up such that it has a “desirable” receiving device and that access by a user of the first receiver to the “desirable” receiving device is permitted. A “desirable” message category is defined which indicates messages which are delivered to a user of the first receiver. The message addressed to the first receiver is checked as to whether it falls into the “desirable” message category. If the message falls into the “desirable” message category, the message is allocated to the “desirable” receiving device.

Depending on the message categories it can be advantageous to carry out the checking as to whether a message falls into the “desirable” message category before checking with regard to the “undesirable” message category. If, for example, comparing the “desirable” message category with the “undesirable” message category results in a lower number of messages which may be delivered, the checking of messages can take place quicker with regard to the “desirable” message category. Conversely it can be advantageous to carry out the checking with regard to the “undesirable” message category before checking with regard to the “desirable” message category if for example the “undesirable” message category is quicker to check. The sequence of checks with regard to the message categories can also be preset and/or managed separately for individual or several, for example grouped, messages.

In a further preferred embodiment the first receiver is set up such that it has an “unknown” receiving device and that access by a user of the first receiver to the “unknown” receiving device is prevented. An “unknown” message category is defined which indicates messages which fall neither into the “undesirable” message category nor into the “desirable” message category. Then it is checked whether the message addressed to the first receiver falls into the “unknown” message category; if it does, the message is allocated to the “unknown” receiving device.

This embodiment prevents messages which for example attempt by using a suitable form not to be classified in the “undesirable” message category, although they actually fall into this category, from being used by the user of the first receiver.

Such “indefinable” or “unknown” messages are received by the “unknown” receiving device where—as stated below—it can be decided whether such messages can be delivered to the user of the first receiver.

To define the message category/ies, it is provided for example to use at least one of the following criteria, parameters etc.:
Details characterizing the sender of messages (e.g. e-mail address, IP addresses, telephone number, sender name, sender postal address)
Message contents (e.g. software and/or hardware by text analysis, voice analysis)
Date and/or time for sending messages (e.g. messages sent to minors at night, messages sent during the lunch break to a first receiver used by a business)
Date and/or time of the arrival of messages (e.g. messages to minors received at night, messages for a first receiver used for a business received during the lunch break)
Systems, components, hardware and/or software etc. used to transmit messages (e.g. insecure Internet servers, foreign telephone connections, private telephone connections [if the transmission of private messages is to be prevented in the field of business], business and/or official telephone connections [if the transmission of business or official messages, e.g. from school, is to be prevented in the field of private life])
Type of message (in order to prevent for example voice messages sent using e-mail from being delivered to the first receiver)
Size of message (in order to guarantee for example that only e-mails of a preset data quantity are delivered to the first receiver)
Frequency of incoming messages.

It is provided in particular to use so-called blacklists and whitelists to define and store such criteria, parameters etc.

Messages which fall into the “undesirable” message category can be identified according to a blacklist; while messages of the “desirable” message category are recognized using a whitelist. The whitelist can preferably be drawn up using an electronic address book (file and/or database with contact data), in particular through an online address book which is on a server and can be used through web access by an authorized person (user). The contact data and addresses, in particular names and e-mail addresses of friends and acquaintances which are among the contacts known and trusted by the user, are entered in the address book. It is thereby ensured that only such messages are classified as “desirable” which have been sent by trusted contacts. The address book is preferably only accessible by the user of the second receiver (parents) and not accessible or accessible only to a limited extent by the user of the first receiver (child). In particular the data can be entered, changed or deleted only by the first receiver (parents). The child has at most read-only rights. Messages which according to a blacklist and a whitelist fall neither into the “undesirable” message category nor into the “desirable” message category can be subjected to e.g. a content monitoring in order to establish the message category into which the message concerned falls.

The first receiver can be set up such that access to the “undesirable” receiving device can only be achieved by a second receiver. This makes possible the use and definition of a monitoring entity which checks the messages of the “undesirable” message category. For example the second receiver can be a receiver used by parents (e.g. an e-mail account), by means of which the parents monitor messages undesirable for their child. In other words: the first receiver can be an e-mail account of a child and the second receiver can be an e-mail account of an adult (parents, teachers etc.) which can prevent the child from having access to undesirable messages, in particular to spam. The “undesirable” receiving device is a corresponding “undesirable” folder in the mailbox of the first receiver (child). The first receiver is thus restricted at least in access to the receiving device or the “undesirable” folder by the second receiver. The second receiver (parent) is in a sense the checking entity for undesirable messages which are aimed at the mailbox of the child and against which the child is to be protected. In addition or as an alternative to the “undesirable” folder an “unknown” folder can also be set up in which incoming messages and messages aimed at the child are collected whose sender and/or content is not clear, i.e. such messages which might probably be damaging to the child.

The first receiver is preferably set up such that access to the “unknown” receiving device can only be achieved by the second receiver. This makes possible the use and definition of a monitoring entity which checks the messages of the “unknown” message category. For example the second receiver can be a receiver used by parents (e.g. an e-mail account), by means of which the parents monitor messages of the “unknown” message category for their child.

In another preferred embodiment the first receiver is set up such that changes to the “undesirable” message category by the user of the first receiver can be prevented and the definition of the “undesirable” message category can only be carried out by the second receiver. In this way manipulations can be prevented which make it possible for messages to be delivered to the first receiver where this is supposed to be prevented.

The first receiver is preferably set up such that changes to the “unknown” message category by a user of the first receiver are prevented and the definition of the “unknown” message category can only be carried out by the second receiver. In this way manipulations can be prevented which make it possible for messages to be delivered to the first receiver where this is supposed to be prevented.

It is also provided that the user of the first receiver can at least partly define the “desirable” message category. This can e.g. take place by the user of the first receiver being able to draw up and/or supplement a whitelist by using details, in particular names, addresses etc. of senders from whom messages are desirable. This can have indirect effects on the “undesirable” message category and, if used, on the “unknown” message category. In order to avoid the checking of messages being bypassed in such embodiments, in such cases the effectiveness of a change by the user of the first receiver can be made to depend on whether the user of the second receiver agrees to the change.

Messages in the “undesirable” receiving device can be monitored by using the second receiver with regard to at least one criterion, parameter etc. (for example see above), in order to check whether the messages in the “undesirable” receiving device really cannot be delivered to the user of the first receiver. E.g. one, several or all of the above-mentioned or further criteria can be used as criteria. This can for example be desirable in order to check whether a used blacklist is sufficiently defined. Messages for which such monitoring was successful can then, managed by the second receiver, be allocated to the “desirable” receiving device. There the messages from the “desirable” message category are available to the user of the first receiver as normal. In order to avoid this in future e.g. the blacklist used can be revised accordingly.

In comparison to this messages of the “unknown” receiving device can be monitored using the second receiver with regard to at least one criterion, parameter etc. (for example see above), in order to check whether the messages in the “unknown” receiving device really cannot be delivered to the user of the first receiver. E.g. one, several or all of the above-mentioned or further criteria can be used as criteria. Messages for which such monitoring has been successful can then, managed by the second receiver, be allocated to the “desirable” receiving device. There they are available as normal messages from the “desirable” message category to the user of the first receiver.

In further preferred embodiments a first e-mail account can be used as a first receiver, to which is allocated an “undesirable” folder for the delivery of messages of the “undesirable” message category and/or a “desirable” folder for the delivery of messages of the “desirable” message category and/or an “unknown” folder for the delivery of messages of the “unknown” message category.

Furthermore it is preferred that—irrespective of the type of the first receiver—an e-mail account is used as a second receiver.

The checking of the message addressed to the first receiver can be carried out before a transmission to the first receiver e.g. by a device used for message transmission (e.g. an e-mail server).

In order to check into which message category the message addressed to the first receiver falls a probability can be ascertained which indicates whether the message falls into the “undesirable” and/or “desirable” and/or “unknown” message category.

It is provided in particular to use a filter to check the message which classifies messages for the first receiver into the message categories. By analogy with approaches used in customary e-mail systems the filter provided in the present invention can be called a spam filter.

Preferably a filter which works as follows is used:

Every message is checked to determine whether it is a desirable message. For example information is used which characterizes the relationships between the first receiver intended to receive the message and a sender of the message such that messages which are consistent with this information can be clearly identified as desirable messages; i.e. a probability of e.g. 0% that it is an undesirable message (e.g. spam) can be defined.

Examples of such information include messages from senders who are recorded in the address book of the first receiver, messages from senders for which the user of the first receiver has defined that messages from this sender are always desirable messages, and messages which are specifically encrypted, encoded or characterized in other ways for the user of the first receiver.

In order to store and manage such information a so-called whitelist can be used.

It is also evaluated whether messages are present which are probably not undesirable messages (e.g. spam), because for example a positive statement about the sender can be found (e.g. because the sender is known as trustworthy). In these cases a low probability of e.g. 1% can be defined that such messages are undesirable messages (e.g. spam). Examples of criteria usable here include messages whose sender is clearly identifiable, messages from paying customers of the server operator, messages from very active customers of the server operator, messages which have been drawn up using the front-end of the server operator, messages which come from senders from a mail domain cleared by the user, messages which are supplied with digital signatures and messages which are supplied with digital signatures whose trustworthiness is ensured respectively by means of a certificate drawn up by a certification authority.

Furthermore it is ascertained which messages are undesirable messages (e.g. spam). Methods such as e.g. frequency measurement, content analysis, header analysis can be used.

Depending on the security with which undesirable messages (e.g. spam) can be recognized, a probability can be defined that a checked message is an undesirable message (e.g. spam). If it is known for example that messages from a specific sender are undesirable, a probability of e.g. 100% can be defined that these messages are undesirable messages (e.g. spam).

For messages for which it cannot be safely ascertained whether they are desirable or undesirable messages, a probability of e.g. 50% or a probability range of 1% to 90% can be defined. Such messages can be filed in the “unknown” message category.

Because the messages are identified as desirable messages, undesirable messages and unknown messages which have not definitively been recognized as desirable or undesirable, the messages are allocated to the “undesirable”, “desirable” or “unknown” devices for receiving; the classified messages are distributed into “undesirable”, “desirable” or “unknown” folders when using files of an e-mail account.

In this way only those messages are allocated to the “desirable” receiving device (“desirable” folder) which with great probability are not undesirable messages, if for example there is a probability equal to or less than 1% that the message is an undesirable message.

Messages can be allocated to the “undesirable” receiving device (“undesirable” folder) which with great probability are undesirable messages, if for example there is a probability equal to or greater than 90% that the message is an undesirable message.

Messages can be allocated to the “unknown” receiving device (“unknown” folder) which with great probability are neither “clearly” recognized as desirable messages nor “clearly” as undesirable messages, if for example there is a probability between 1% and 90% that the message is an undesirable message.

Because the second receiver functions by monitoring messages to the first receiver, the second receiver can be called superordinate receiver or master receiver and the first receiver subordinate receiver or slave receiver (e.g. master account and slave account in the case of e-mails).

The security can thereby be increased by the second receiver being enabled to access desirable messages delivered to the first receiver, advantageously independently of the corresponding checking results. In this way for example it can be checked whether the criteria used to define the “undesirable” message category must be changed, supplemented or modified. In this way it can also be established whether it is possible to bypass the checking of messages sent to the first receiver.

The present invention also delivers a system for monitoring messages which includes a first receiver which has an “undesirable” receiving device and is set up such that access by a user of the first receiver to the “undesirable” receiving device is prevented, a second receiver to define an “undesirable” message category which indicates messages which are to be prevented from being delivered to a user of the first receiver, and an apparatus to check whether a message addressed to the first receiver falls into the “undesirable” message category, and to allocate the message to the “undesirable” receiving device if the message falls into the “undesirable” message category.

Preferably the first receiver has a “desirable” receiving device and is set up such that access by a user of the first receiver to the “desirable” receiving device is permitted, wherein the second receiver is set up to define a “desirable” message category which indicates messages which are to be delivered to a user of the first receiver. The checking device is set up here in order to check whether the message addressed to the first receiver falls into the “desirable” message category, and in order to allocate the message to the “desirable” receiving device if the message falls into the “desirable” message category.

In a further preferred embodiment the first receiver has an “unknown” receiving device and is set up such that access by a user of the first receiver to the “unknown” receiving device is prevented, wherein the second receiver is set up to define an “unknown” message category which indicates messages which do not fall into the “undesirable” message category or into the “desirable” message category. The checking device is set up here to check whether the message addressed to the first receiver falls into the “unknown” message category and to allocate the message to the “unknown” receiving device if the message falls into the “unknown” message category.

The first receiver is preferably set up so that the “undesirable” receiving device and/or “unknown” receiving device can only be accessed by the second receiver.

The second receiver can be set up to monitor the “undesirable” receiving device and/or “unknown” receiving device and if desirable to allocate monitored messages to the “desirable” receiving device which the first receiver can access.

In preferred embodiments the first receiver is a first e-mail account to which at least one “undesirable” folder is allocated which serves as the “undesirable” receiving device.

Using a “desirable” message category and/or an “unknown” message category, the first e-mail account can have a “desirable” folder serving as the “desirable” receiving device or an “unknown” folder serving as the “unknown” receiving device.

The second receiver is (also) preferably an e-mail account.

The checking device can include a filter which categorizes the message addressed to the first receiver in the “undesirable” message category if the message falls into the “undesirable” message category.

The checking device can also include a filter which categorizes the message addressed to the first receiver in the “desirable” message category if the message falls into the “desirable” message category.

The checking device can also include a filter which categorizes the message addressed to the first receiver in the “unknown” message category if the message falls into the “unknown” message category.

The filter(s) is (are) preferably provided with a device comparable to a spam filter which can be included by the first receiver or be a component of a device which sends messages to the first receiver and/or is used in the first receiver to receive messages, such as for example e-mail server, e-mail browser etc.

Furthermore it is preferable that in filtering messages to the first receiver one or more probabilities is calculated that a message falls into one of the message categories.

### BRIEF DESCRIPTION OF THE FIGURES

In the preferred embodiments of the following description reference is made to the attached figures, in which are shown:

FIGS. 1 to 11 schematic representations of graphic user interfaces for an embodiment of the method according to the invention and

FIG. 12 a schematic representation of an embodiment of the system according to the invention.

### DESCRIPTION OF PREFERRED EMBODIMENTS

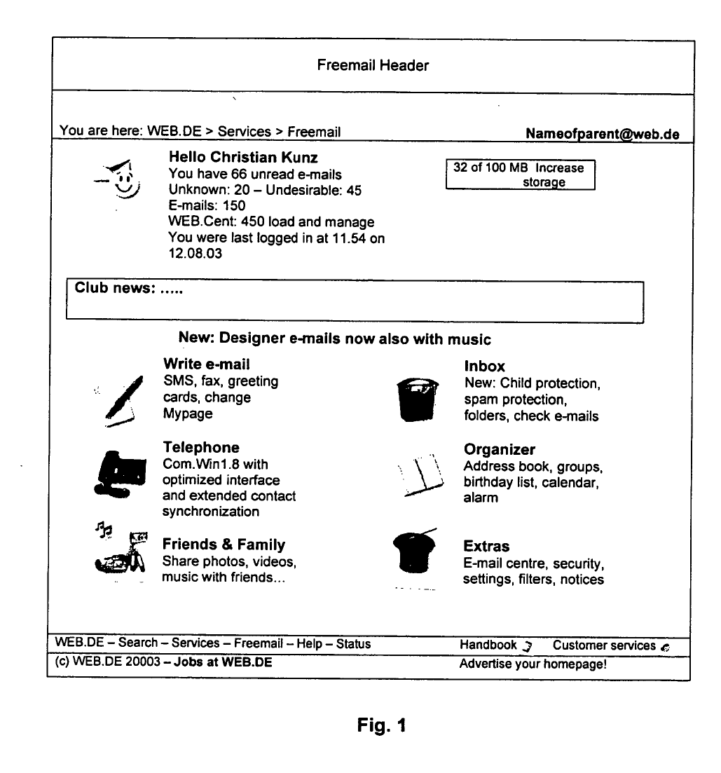

A preferred embodiment is described below with reference to FIGS. 1 to 11 in which messages in the form of e-mails for a first receiver designated a child-protection account are checked by means of measures designated child protection as to whether messages are to be delivered to a child-protection account. Here a so-called parent account is used as second receiver.

A normal e-mail account is taken as a basis here, to which three folders are allocated into which e-mail can be delivered. The three folders are called the “undesirable” folder for e-mails falling into the “undesirable” message category, the “desirable” folder for e-mails falling into the “desirable” message category and the “unknown” folder for e-mails falling into the “unknown” message category. A parent account is one such normal e-mail account.

The child-protection account differs among other things in the following points from a normal e-mail account. For each child-protection account there is exactly one parent account. Only specific e-mail functions are available in child-protection accounts. The “undesirable” and “unknown” folders are only available through the parent account (e.g. reading, deleting, copying, forwarding etc.) and cannot be seen in the child-protection account. The “desirable” folder is only available in the child-protection account; access to this folder is not generally possible via the parent account, in order to protect the private sphere of the child. However, it is also possible to enable access to the “desirable” folder via the parent account in order to achieve complete control of the communication behaviour of the child; such an access possibility also allows checking of whether the criteria used to evaluate e-mails addressed to the child (e.g. filter parameters, blacklist and whitelist entries) are defined such that the child really only receives desirable e-mails. If it is established when checking the “desirable” folder that undesirable and/or unknown e-mails are present there, this suggests that this is due to unsatisfactory monitoring or insufficient criteria and/or bypassing possibilities being used by e-mail senders or the child.

It is also not to be possible with a child-protection account to deactivate spam protection or filters, to display the “unknown” and “undesirable” files, to completely delete the e-mail mailbox and to change the date of birth in order to manipulate age-dependent deactivation of the child protection described below.

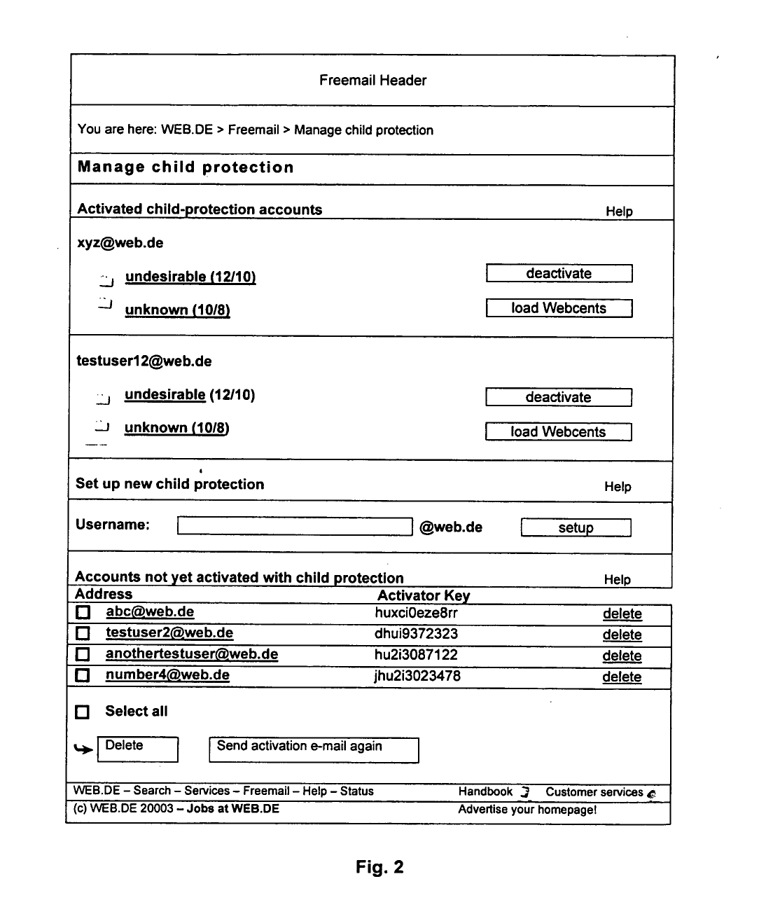

On the homepage of the parent account shown in FIG. 1 a link to the child protection is found under the “incoming mail” heading. Clicking on this link takes you to the page shown in FIG. 2 “manage child protection”. The “manage child protection” page is essentially divided into three areas.

In the upper area called “activated child-protection accounts” there is an overview of the already-activated child-protection accounts which are allocated to the parent account. These are set-up and activated child-protection accounts.

Access to the “unknown” and “undesirable” files respectively of the child-protection account is granted from the parent account, from which this can be processed. Moreover, the individual child-protection accounts can be deactivated again from here. After deactivation a child-protection account again becomes a normal e-mail account.

Further child-protection accounts can be set up in the area below called “set up new child protection”. Here, simply the user name of the desirable account need be entered. Further indications in this regard are given further below.

The middle area designated “not-yet-activated child-protection accounts” represents the set-up, but not-yet-activated child-protection accounts. A child-protection account is only activated if an activator key is entered as described below. Accounts which have been set up thus far but not activated can be deleted again.

Deleting not-yet-activated child protection is also a condition for setting up a new child protection for the mailbox involved.

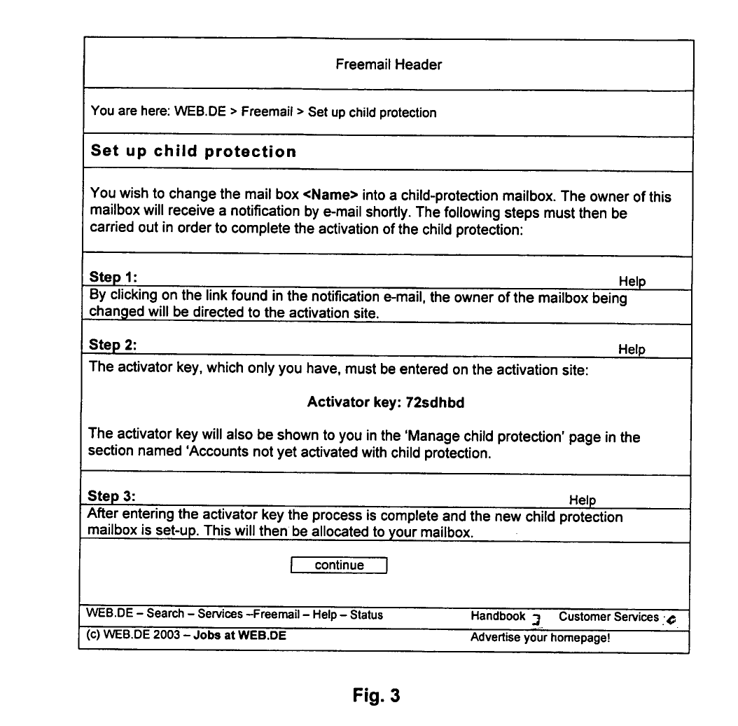

After entering the name of an e-mail mailbox in the “new child protection set up” area on the “manage child protection” page in FIG. 2 and after fulfilling all the necessary conditions (age of the target mailbox owner etc.) a page illustrated in FIG. 3 appears with “set up child protection” from the parent account. Further steps to activate the child-protection account are explained there.

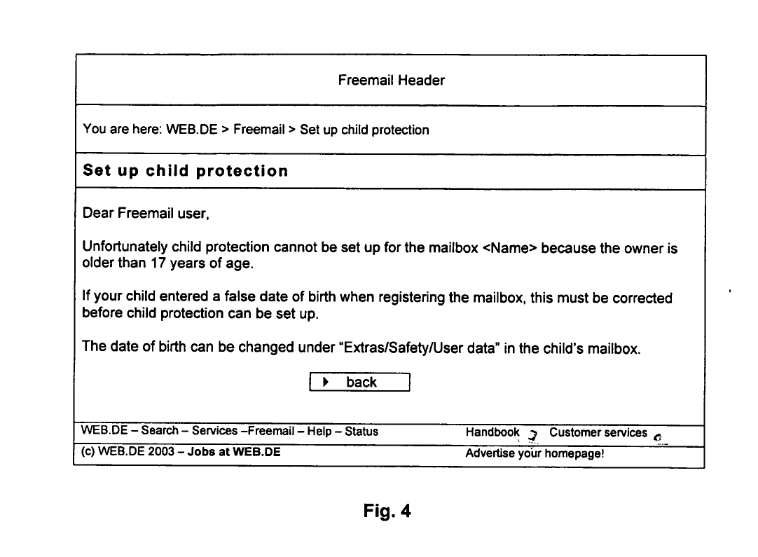

If a child-protection account is to be set up for a child older than 17 years of age, after activating the “set up” pinboard (see FIG. 2: “set up new child protection” area) a reference page shown in FIG. 4 is displayed. This also contains information about where the date of birth can be changed. Thus, upon reaching a preset minimum age (e.g. 17 years of age), the setting-up of such a child account and thus monitoring by a parent account is blocked, depending on the age of the user (child) of the first receiver (child account). It is thereby avoided that child accounts can still be set up for older children who are almost at the age of majority which for legal reasons must then be deleted or converted into normal accounts a short time later upon reaching the age of majority.

If, however, a child account already exists and a child for whose account child protection is activated reaches the corresponding age of majority (e.g. 18 years of age), then both the parents and the child receive a communication with the content that the child protection is deactivated. The child protection is then automatically removed, wherein the child-protection account and the parent account respectively are converted into normal accounts. The link to or dependency thus far on the parent account of the children account is automatically cancelled when a minimum age indicating the age of majority of the child is reached. This communication can take place by e-mail, which the parents and the child find in the corresponding “desirable” files when they next log in to the former parent account or the former child-protection account.

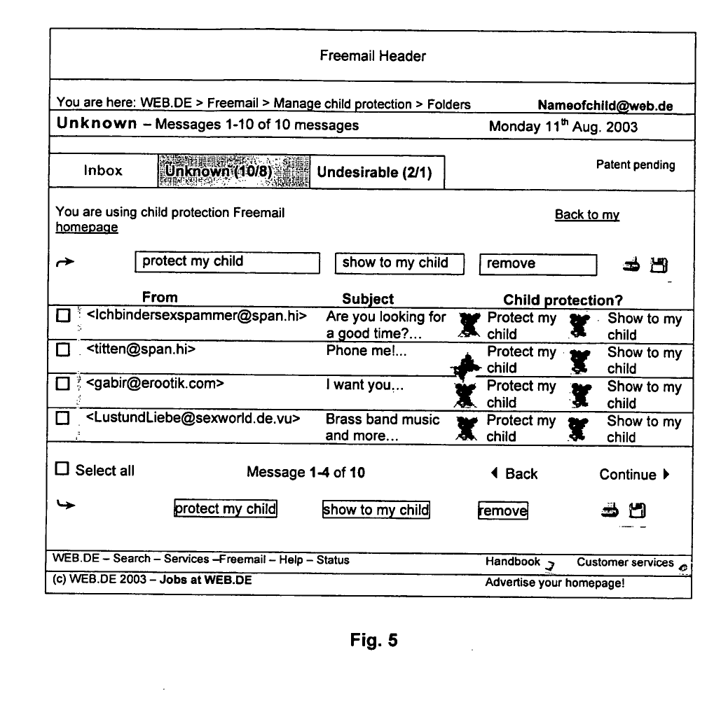

Starting from the parent account, if a folder link to a child-protection account is clicked on the “manage child protection” page, the user is passed through to the page called “folder overview”, represented in FIG. 5. The “folder overview” page is represented in different colours (e.g. green) in order to achieve an additional delimitation from the incoming mail of the parent account.

So that the owner of a parent account has access to e-mails of child-protection accounts it is advantageous if the mailboxes of the parent and child-protection accounts are administered in a database in order to avoid data transmission in the case of access to e-mails of a child-protection account starting from the parent account.

There is the possibility here of marking individual e-mails in the corresponding child-protection account as “desirable” or “undesirable” if the “protect my child” button is pressed for undesirable e-mails or the “show to my child” button is pressed for desirable e-mails. In this way the parent can influence which e-mails arrive in the incoming mail of the child-protection account and thus which e-mails the child is allowed to see. If an e-mail is marked in this way as desirable the corresponding e-mail is moved into the inbox; an entry as “desirable sender” can be generated for such an e-mail. If an e-mail is marked as undesirable a so-called blacklist entry is generated.

As the owner of the parent account has no access to incoming mail from child-protection accounts the incoming mail of the child-protection account chosen here is represented in a manner indicating this prevention of access.

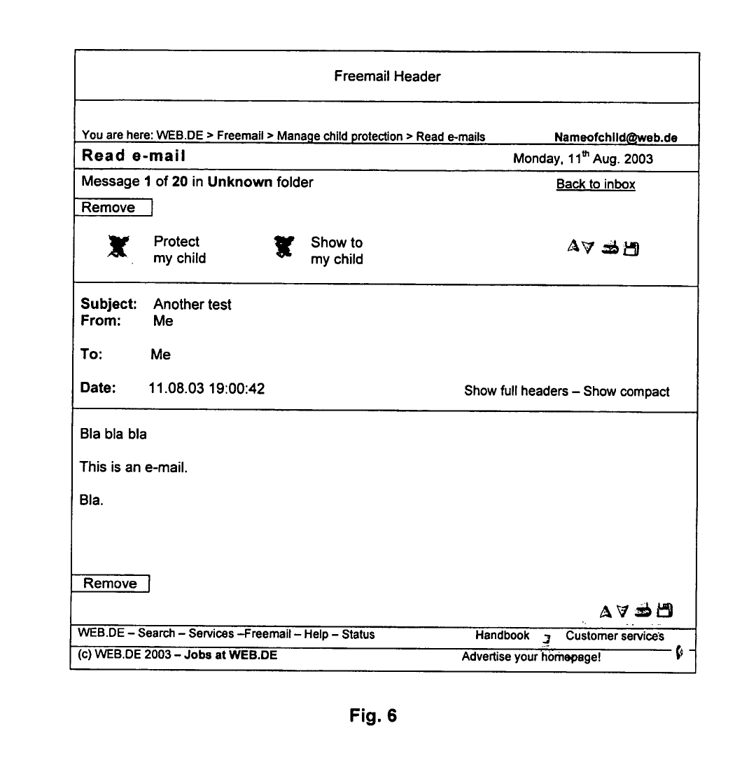

If an e-mail indicated under the “unknown” or “undesirable” category is opened starting from the “folder overview” page, the “read e-mail” page represented in FIG. 6 is presented. Via the “protect my child” and “show to my child” buttons shown here the functionalities of the above-described buttons of the same name are activated. Pressing the “remove” button has the effect that the displayed e-mail is definitively deleted.

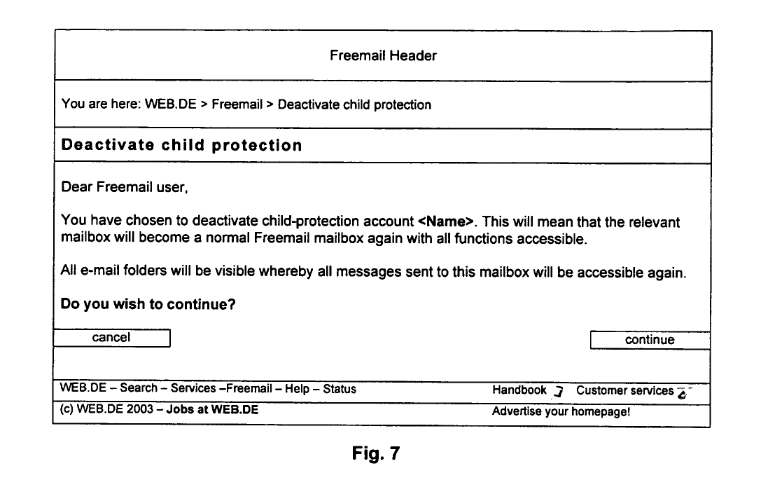

In order to deactivate a child-protection account, i.e. to turn the account concerned back into a normal e-mail account, and in order to cancel the link between parent and child-protection account there is the “deactivate” button for each activated child-protection account on the “manage child protection” page represented in FIG. 2. If this is activated the user is passed through to the “deactivate child protection” page represented in FIG. 7. There, deactivation can be cancelled or actually carried out, wherein reference is made to the consequences of deactivation.

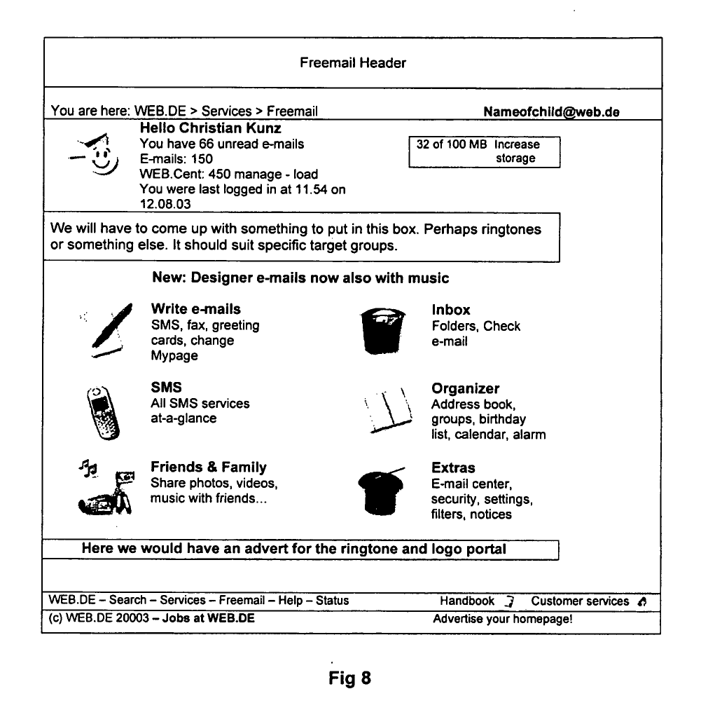

The homepage of a child-protection account represented in FIG. 8 differs due to the limited functionalities of a child-protection account from the homepage of a parent account represented in FIG. 1.

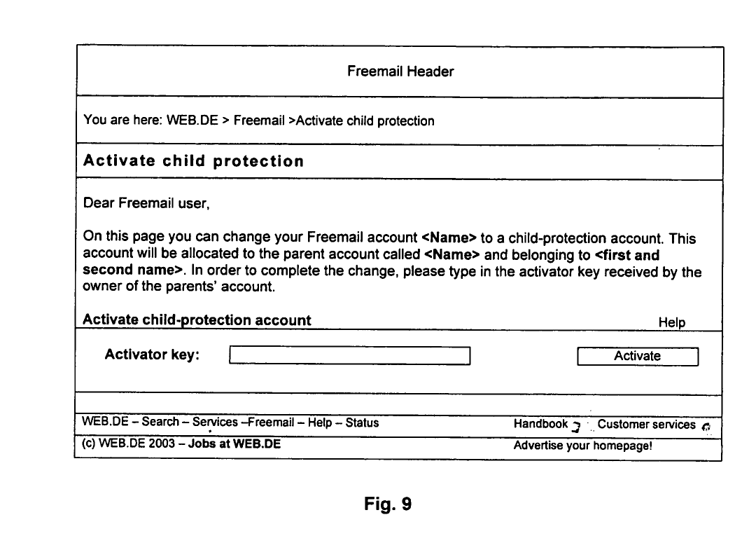

In order to prevent misuse in the setting-up of the child-protection account, after the above-described setting-up of a child-protection account an e-mail is sent from a parent account to the account which is to become a child-protection account. Such an e-mail delivers a link by means of which access is obtained to the “activate child-protection” page represented in FIG. 9. The previously generated activator key is entered there which is only available to the owner of the parent account.

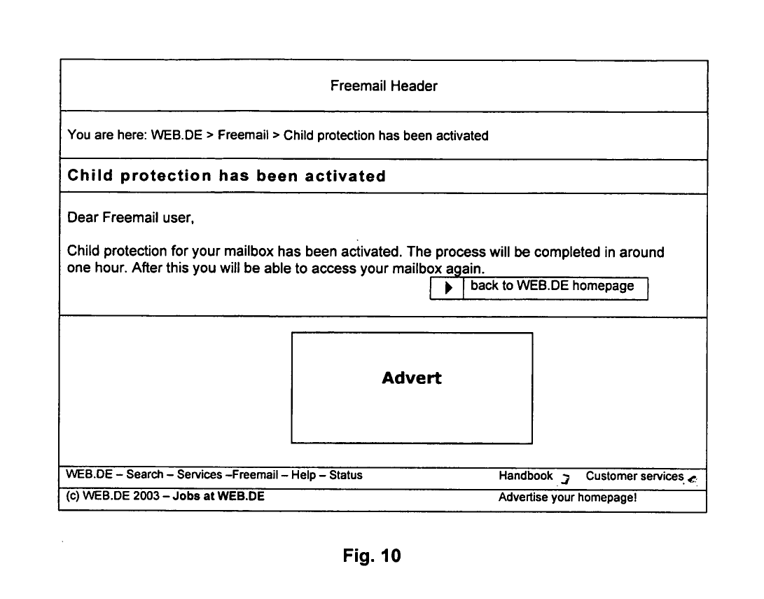

After successfully concluding the activation process the page represented in FIG. 10 appears. This advises that the activation process will be concluded for example in approximately one hour.

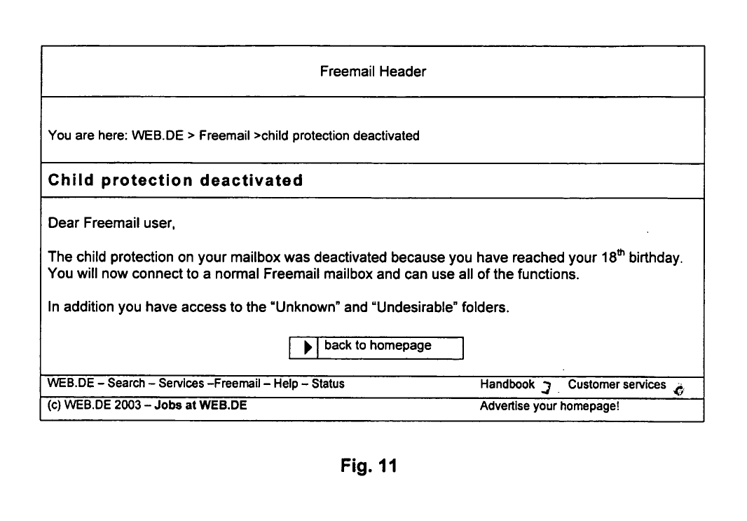

If child protection is deactivated from a parent account, when he next logs in the child will find a corresponding e-mail in his “desirable” folder. If a child-protection account is deactivated because the owner is too old he also receives information about this via e-mail and/or via the page shown in FIG. 11.

In all cases, one consequence of deactivating a child-protection account is that the child-protection account is converted into a normal account. Then all customary functions of a normal account are available to the user of the former child-protection account; in particular the user has access to the “undesirable”, “unknown” and “desirable” folders.

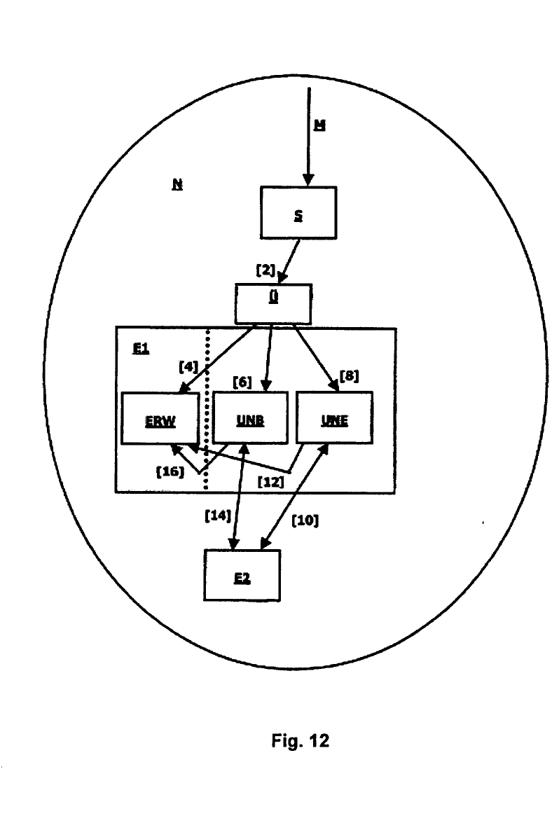

FIG. 12 schematically shows a further embodiment with a communication network N (e.g. the Internet) in which a sender (not shown) wishes to send a message M to a user (not shown) of a first receiver E1. Transmission of the message in the network N takes place by managing a central device S (e.g. e-mail server) and optionally the apparatuses and/or devices (e.g. gateways, routers, network operators etc.)—not shown here—allocated to the device S.

In order to indicate that the message M is aimed at the first receiver E1 data are allocated to the message M which indicate the first receiver E1 as addressee (e.g. e-mail address). The device S (or message transmission apparatuses and/or devices thus used) recognizes, using such address data, that the message M is to be transmitted to the first receiver E1.

Using the address data it is also established whether the message M aimed at the first receiver E1 is to be monitored regarding the message category into which the message M falls.

If a monitoring of the incoming message M is to take place in the central device S the message M is forwarded to a monitoring device Ü (step [2]). In the represented embodiment the monitoring device Ü is allocated to the central device S or integrated into this. Alternatively it is possible to allocate the monitoring device Ü to the first receiver E1 or to integrate it into this.

The received message M is classified by the monitoring device U as to the message category into which the message M falls. Advantageously the monitoring device Ü is set up such that in order to classify the message M probabilities are calculated with which the message M falls into one of the message categories.

A so-called blacklist and a so-called whitelist can be used for this purpose. Such lists can be present in a memory area of the central device S allocated to the first receiver E1.

Information is indicated in the blacklist by means of which it is (clearly) possible to identify messages as desirable messages. In contrast information is present in the whitelist which makes possible a (clear) identification of messages as undesirable messages. Using the blacklist and the whitelist and optionally using further methods of evaluating messages (e.g. content analysis, header analysis etc.) probabilities can be calculated for messages as to whether messages fall into the “undesirable” message category, into the “desirable” message category or into the “unknown” message category.

If the monitoring device Ü establishes that the message M falls into the “desirable” message category, the message M is transmitted to the receiving device ERW (“desirable”) (step [4]).

If the transmission apparatus Ü establishes that the message M falls into the “unknown” message category, it is allocated to the receiving device UNB (“unknown”) (step [6]).

If, in the checking of the message M by the checking device Ü, it arises that the message M falls into the “undesirable” message category, the receiving device UNE (“undesirable”) receives the message M (step [8]).

A user of the first receiver E1 cannot access the receiving device UNE and the receiving device UNB; access to the receiving device ERW is possible for the user of the first receiving device E1. This is shown in FIG. 12 by the dotted line. In contrast, accessing the receiving device UNB and the receiving device UNE is possible on the part of the user of the second receiver E2, while accessing the receiving device ERW is not generally possible.

If the user of the second receiver E2 wishes to check messages of the receiving device UNE, he accesses this receiving device (step [10]). This enables the user of the second receiver E2 to delete undesirable messages. The user of the second receiver E2 can also check undesirable messages again to see whether a message, despite having been classified in the “undesirable” message category, is to be delivered to the user of the first receiver E1. If this is the case, the user of the second receiver E2 can allocate such messages to the receiving device ERW (step [12]).

In comparison to this it is possible for the user of the second receiver E2 also to access unknown messages of the receiving device UNB, to delete unknown messages or optionally to deliver them to the receiving device ERW (steps [14] and [16]).

The invention can be used not only in e-mail systems and e-mail services, in particular in so-called freemail services, but also in any communications system in which messages are received, thus e.g. also in mobile communications systems and services. In this connection e.g. the first receiver can be the mobile communications account of a child and the second receiver can be the mobile communications account of a parent (father or mother of the child). With incoming SMS or MMS messages which are aimed at the child or at its account, the second receiver checks whether the messages are desirable or not. This happens e.g. using the mobile telephone number of the sender (calling party number). The parent can block access to undesirable SMS and/or MMS messages so that the child is protected against them.

1-25. (canceled)

26. Method of monitoring messages addressed to a first receiver (E1) in which the first receiver (E1) is a first set-up user account in a communications service and is set up such that it has an “undesirable” receiving device (UNE),
the first receiver (E1) is set up such that access by a user of the first receiver (E1) to the “undesirable” receiving device (UNE) is prevented,
an “undesirable” message category is defined which indicates messages which are to be prevented from being delivered to a user of the first receiver (E1),
it is checked whether a message (M) addressed to the first receiver (E1) falls into the “undesirable” message category,
the message (M) is allocated to the “undesirable” receiving device (UNE) if the message (M) falls into the “undesirable” message category, and
the first receiver (E1) is set up such that the “undesirable” receiving device (UNE) can only be accessed by a second receiver (E2), which is a second set-up user account in the communications service.
